(19) United States
(12) Patent Application Publication
(10) Pub. No.: US 2018/0338472 A1
(43) Pub. Date: Nov. 29, 2018

(54) PET TRAINING SYSTEM

(71) Applicant: Ashleigh Industries, LLC, Atlanta, GA (US)

(72) Inventors: Ashleigh Kinsley, Loganville, GA (US); Michael Jenkins, Atlanta, GA (US); K. Daniel Hooper, Atlanta, GA (US)

(21) Appl. No.: 15/991,425

(22) Filed: May 29, 2018

Related U.S. Application Data
(60) Provisional application No. 62/511,578, filed on May 26, 2017.

(51) Int. Cl. A01K 15/02; A01K 27/00

(52) U.S. Cl. CPC A01K 15/021; A01K 11/008; A01K 27/009

(57) ABSTRACT

Disclosed herein is a pet training system that includes a sensing device that is configured to signal a user when a pet is in the proximity of a selected location and a collar module that is configured to be fixed to a collar worn by the pet. A software application is configured to sense a disturbance or permutation in the environmental average magnetic vector, which disturbance is the result of the presence of a localized magnetic field generated by collar module. The pet training system further is configured to warn the user that the pet is within the sensed proximity of the selected location upon confirmation that a determined scaler magnetic state value exceeds a selected scalar threshold value.

### CROSS-REFERENCE TO RELATED APPLICATIONS

This application claims the benefit of U.S. Provisional Patent Application No. 62/511,578, filed on May 26, 2017, which is incorporated by reference in its entirety herein and for all purposes.

### FIELD OF USE

This invention relates to pet training systems. More particularly, the present disclosure relates to signal assemblies actuatable by pets for signaling humans.

### BACKGROUND

Owners of pets often allow the pet to live primarily indoors and allow the pet to only occasionally exit the home unattended. The intervals at which the pet, such as a dog or a cat, are let outdoors to relieve themselves are often dictated by the pet. For instance, many pets are well trained to relieve themselves only in the outdoors and so must be given frequent access to the outdoors according to the pet's biological needs. While pet doors and other devices have been provided that allow the pet to exit or enter the home at will, these devices are often problematic in that they typically permanently and undesirably alter doors and door frames, and can allow unwanted, animals or pets may use the doors to enter or leave the home. In addition, many pet owners may wish to limit the time a pet spends outdoors for considerations such as the pet's safety, nuisance noise the pet may generate, weather conditions, etc.

Due to these factors, many owners rely on the pet to indicate when the pet wishes to enter or leave the home and personally attend to a door to let the pet into or out of the home. Because owners are often busy attending to other matters, they may not notice that a pet is standing by a door desiring to be let out. In such situations, the pet may become impatient and begin barking or otherwise creating noise, or, even more problematic, may begin scratching or pawing at the door in an effort to open the door or to signal to the owner the pet's desire to be let out. This can be problematic in that the pet can become a nuisance and can cause considerable damage to the door.

Conventional pet signaling devices often must be permanently affixed to a housing structure, which can be costly, due to the time and resources required for installation, and are prohibitive in that they cannot be easily moved and thereby used in connection with more than one door. Due to their immobile nature, conventional pet signaling devices also cannot be used away from the home.

In addition, conventional pet signaling devices often utilize an audio sensing device that is remote from the signaling assembly. This can lead to more expensive and less reliable signaling systems, as the system includes a greater number of components and a correspondingly higher probability for failure of one or more components of the system. Also, audio signaling devices are limited in applications where either the human or the pet is hearing impaired.

Accordingly, it would be desirable to develop a signaling assembly that can be activated by a pet to indicate the pets desire to be let into or out of a house or other dwelling. In addition, it would be advantageous to develop a pet-activated sensing device that can produce a variety of signal types which can be varied according to a particular application.

### SUMMARY

The disclosure relates to a pet training system comprising a sensing device that is configured to signal a user when a pet is in the proximity of a selected location. The sensing device can comprise a base and a cover configured to be selectively coupled to the base. The pet training system further comprises a collar module that is configured to be fixed to a collar worn by the pet.

A software application, which can be resident in the sensing device or at a remote server, is configured to sense a disturbance in the environmental average magnetic vector, which disturbance is the result of the presence of a localized magnetic field generated by collar module. The software application can calculate a scaler magnetic state value in proximity to the sensing device based on the sensed magnetic flux on the X, Y and Z axes-axis, and compare the determined scaler magnetic state value to a selected scalar threshold value. The software application is further configured to alert the user of the disturbance when the scaler magnetic state value exceeds the selected scalar threshold.

Optionally, the software application can further be configured to determine a pet dwell time based on the time that the sensed disturbance occurs. As such, if the pet dwell time exceeds a predetermined dwell time, which can be selectively set by the user, the user is notified of the pet's presence at the selected door. Further, the software application can be configured to determine and affect the user selected means of notification.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is a schematic view of one aspect of a pet training system showing a collar module fixed to collar on a pet and a sensing device, and showing the collar module, comprising a permanent magnet, positioned within a sensing range of the sensing device. The figures further shows the sensor coupled, via conventional home WIFI to a cloud service for subsequent warning delivery to a user's personal device.

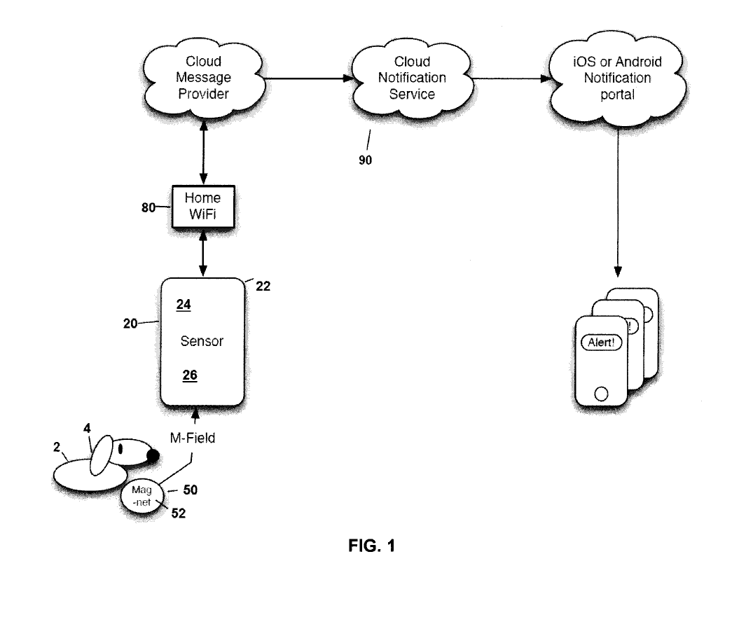

FIG. 2 is a schematic view of one aspect of a pet training system

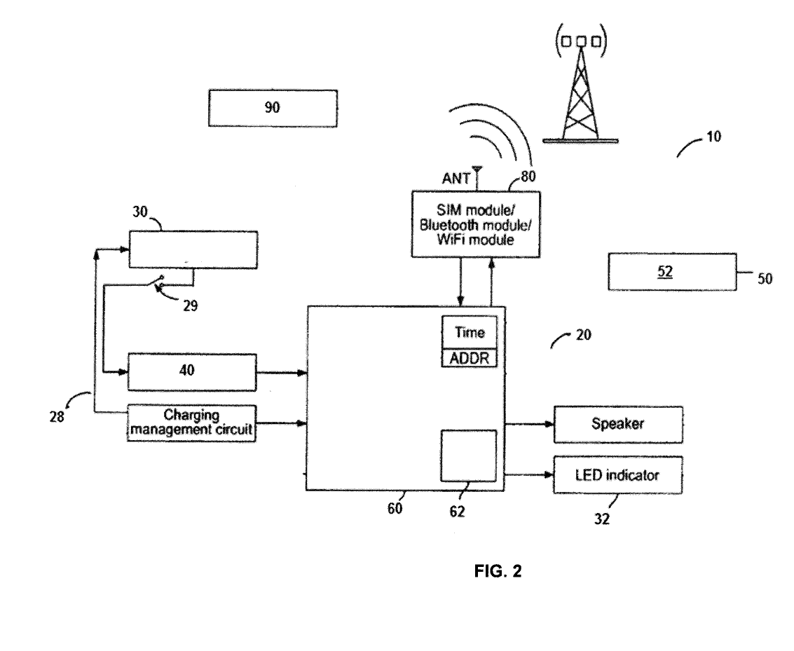

FIG. 3 is a schematic block diagram representing the components of the sensing device of the pet training system.

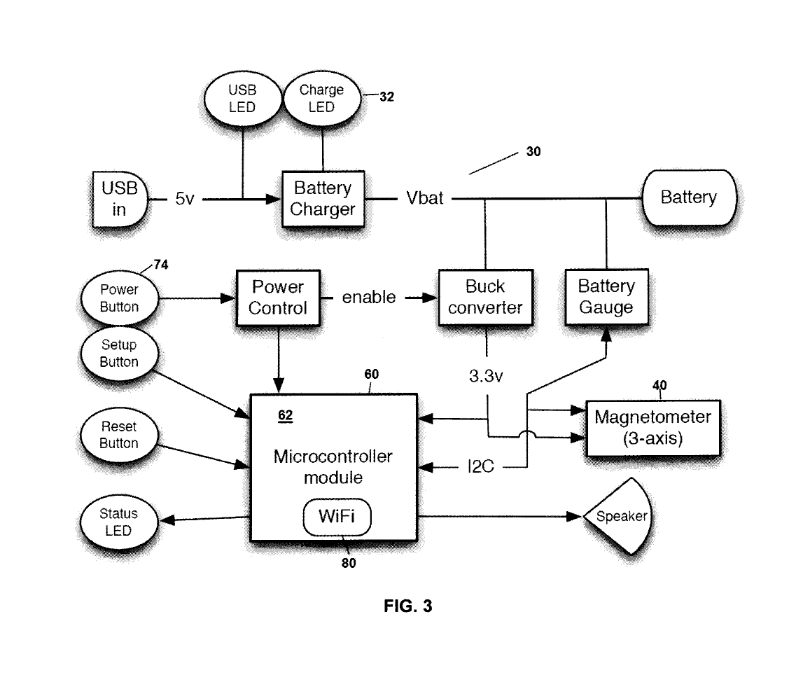

FIG. 4 is a schematic flow diagram of the magnetic flux is each of the X, Y, and Z axes being passed though respective third-ordered bandpass filters to produce a sensed and filtered magnetic flux for each of the respective axes and showing the sensed and filtered magnetic fluxes being used to determine a scaler magnetic state value that can then be compared to a selected scalar threshold value. If the scaler magnetic state value exceeds the selected scalar threshold value, the user is set an alert.

FIG. 5 is a schematic flow diagram of a software application of the pet training system, showing a connectivity thread the can move between a low energy conservation mode, when the system determines that the scaler magnetic state value does not exceed the selected scalar threshold value, and a high energy mode, when the system determines that the scaler magnetic state value exceeds the selected scalar threshold value and WIFI connection is required to process the alert or warning to the remote user.

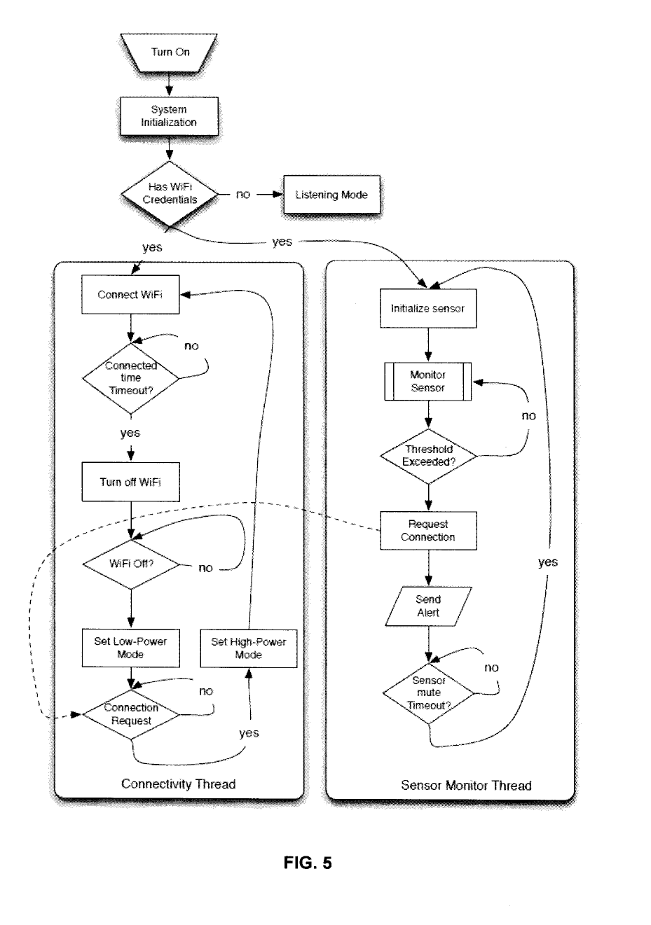

### DETAILED DESCRIPTION

The present invention can be understood more readily by reference to the following detailed description, examples, and claims, and their previous and following description. Before the present system, devices, and/or methods are disclosed and described, it is to be understood that this invention is not limited to the specific systems, devices, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. Those skilled in the relevant art will recognize that many changes can be made to the aspects described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “magnet” includes aspects having two or more magnets unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes examples where said event or circumstance occurs and examples where it does not.

The disclosure relates to a pet training system 10 comprising a sensing device 20 that is configured to signal a user when a pet 2 is in the proximity of a selected location, which is identified herein for convenience as a selected door, and a collar module 50 that is configured to be fixed to a collar 4 worn by the pet 2. In one aspect, the collar module 50 comprises a permanent magnet 52 that has a magnetic field strength of between about 0.1 T to about 2.5 T, preferably between about 0.4 T to about 1.4 T, and most preferred between about 0.6 T to about 1.0 T. Optionally, the permanent magnet 52 can be encapsulated in an enclosure or otherwise integrated and enclosed within the structure of the pet collar to insure that the permanent magnet 52 cannot be ingested by the pet.

In another aspect, the sensing device 20 can comprise a base 22 and a cover 24 configured to be selectively coupled to the base 22 to form an enclosure 26. The sensing device further comprises a circuit 28 that can include at least a power source 30, such as a rechargeable or replaceable battery, a magnetic field sensor 40, such as a magnetometer and the like, that is capable of sensing magnetic flux on each of three axes, a processor 60 operably coupled to the magnetic field sensor 40, and a memory 62 operably coupled to the processor. The signal device can further comprise a LED power indicator 32 for indicating that the circuit 28 is in an active or “on” state, as opposed to a hibernation or “off” state. A power button 74 can be further included for activating the circuit 29 by the user.

Upon actuation of the pet training system 10 via the actuation of the power button 74, the magnetic field sensor 40 is configured to measure magnetic flux on each of three cardinal axes to determine the value of the environmental magnetic flux on each of the three axes. As one skilled in the art will appreciate, the processor can be programmed to analyze environmental factors such as the Earth's magnetic field and other localized magnetic sources such as magnetic fields generated by nearby electronic devices in communication.

In one embodiment and upon actuation of the pet training system 10 via the actuation of the power button 74, a software application which can be resident in the sensing device or at a remote server, can be configured to signal the magnetic field sensor 40 to measure magnetic flux on each of three cardinal axes (X-axis, Y-axis, and Z-axis) to determine the value of the environmental magnetic flux on each of the respective three axes for the room in which the pet training system 10 is mounted. Preferably, the magnetic field sensor 40 can make at least one measurement upon startup of the magnetic flux to determine the value of the environmental magnetic flux on each of the three axes. The value of the environmental magnetic flux on each of the three axes can then be processed to determine an environmental magnetic vector which is stored in the memory 62.

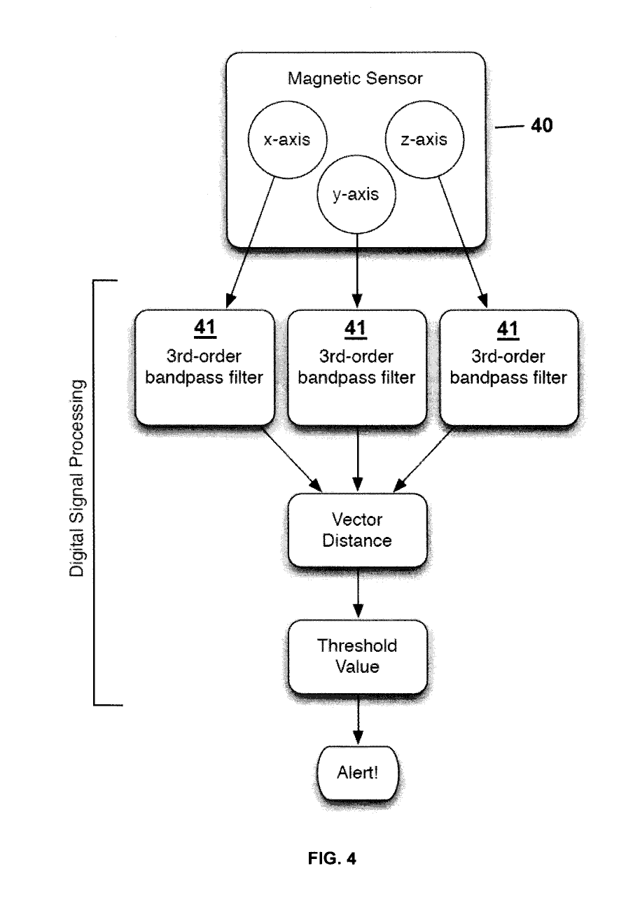

The determined value of the environmental magnetic flux on each of the respective three axes is used to initialize a plurality of n-ordered bandpass filters 41, where n is at least 2. In one example, the plurality of n-ordered bandpass filters comprises a plurality of third-ordered bandpass filters 41. In this aspect and as shown in FIG. 4, one third-ordered bandpass filter is configured to receive the sensed magnetic flux from a respective axis of the magnetic sensor, i.e., a first third-ordered bandpass filter is configured to receive the sensed magnetic flux from the X-axis, a second third-ordered bandpass filter is configured to receive the sensed magnetic flux from the Y-axis, and a third third-ordered bandpass filter is configured to receive the sensed magnetic flux from the Z-axis. The exemplary third-ordered bypass filter is a combination of a low-pass and a high-pass filter that is configured to only allow passage of a desired spectrum of middle frequencies. In this aspect, for example and without limitation, the exemplary third-ordered bypass filter can be configured to allow the passage of frequencies of between about 0.001 Hz to about 0.040 Hz, preferably between about 0.005 Hz to about 0.035 Hz, and more preferred between about 0.010 Hz to about 0.030 Hz. In this configuration, one skilled in the art will appreciate that the high-pass portion of the third-ordered bypass filter is configured to filter environmental noise out and the low-pass portion of the third-ordered bypass filter is configured to make the sensed magnetic readings less noisy and more sensitive. Thus it is contemplated that the plurality of third-ordered bandpass filters 41 are configured to cancel the local static magnetic field, heuristically adapt to changing environmental magnetic conditions, filter irrelevant noise, and increase the accuracy and sensitivity of the measurements.

As one will appreciate, the permanent magnet 52 coupled to the collar creates a localized magnetic field which can be sensed by a magnetic field sensor 40. Thus, when a pet wearing a collar 4 having the attached collar module 50 is in proximity to the magnetic field sensor 40, the magnetic field proximate the sensing device will change.

In operation, the magnetic field sensor will continuously measure three orthogonal components (X-axis, Y-axis, and Z-axis) of the magnetic field and input these measurements into the plurality of third-ordered bandpass filters 41. In one aspect, it is contemplated that the magnetic field sensor can be configured to continuously sense for changes or permutations in the magnetic field or, optionally, can be configured to sense at user select intervals, such as, for example and without limitation, every 10 seconds, ever 20 second, and the like. In a further optional aspect, the sensitivity of the magnetic field sensor can be selected by the user to affect the sensed range of the magnetic field sensor.

In a further aspect and in operation, a software application, which can be resident in the sensing device or at a remote server, can be configured to calculate a present magnetic state vector based on the measured three axis values of magnetic flux generated by the plurality of third-ordered bypass filters 41. The software application further is configured to combine the measured three axis values of the present magnetic state vector into a scaler magnetic state value for subsequent comparison to a scalar threshold value. The scaler magnetic state value is determined by using the following formula:

scaler magnetic state value=SQRT(x̂2+ŷ2+ẑ2),

where x, ym and z are the measured three axis values of magnetic flux for the respective X, Y, and Z axis generated by the plurality of third-ordered bandpass filters.

In one aspect, it is contemplated that the scalar threshold value can be selectably inputted or adjusted by an operator which provides the system with a means of controlling the sensitivity and range of the sensor. In one aspect, if the scaler magnetic state value exceeds the selected threshold, the processor will determine that the pet collar is in the proximity of the selected door.

Optionally, the software application resident on the sensing device can further be configured to determine a pet dwell time based on the time that a filtered threshold is exceeded. In this optional aspect, if the pet dwell time exceeds a predetermined dwell time which can be selectively set by the user, the user is notified of the pet's presence at the selected door. In a further optional aspect, the software application can enforce a cool-down timeout period, which prevents undesirable detections once a pet collar is detected and allows time for the pet to clear the area proximate the sensor, serving to prevent the pet collar from influencing bandpass filter re-initialization.

The pet training system 10 can also comprise means for warning the user that the pet is within the sensed proximity of the selected door. The means for warning the user can comprise at least one of an audio transducer, such as a buzzer, speaker, piezoelectric buzzer, and the like, as is known in the art, and a light indicator, such as a LED indicator. In one aspect, the audio transducer and/or light indicator can be on the sensing device. In an optional aspect, it is contemplated that the sensing device can wirelessly communicate to remote audio transducers and/or light indicators so that the user can select the locations of the warning apparatus.

In a further aspect, it is contemplated that means for warning the user that the pet is within the sensed proximity of the selected door can comprise at least one remote server 90 and a wireless transmitter 80 that is coupled to the processor 60 and is stored within the enclosure of the signal device. In this aspect, after determining the presence of a scaler magnetic state value which exceeds the scalar threshold value, the transmitter 80 is configured to relay a warning signal containing a unique identifier of the signal device and/or the collar module to the remote server 90. Subsequently, a software application on the server 90 can route the warning signal in an appropriate notification form based on the end user's preferences. In this aspect, it is contemplated that the user can have a portable electronic device, such as a smart mobile phone, or the like, that has at least a wireless transmitter, a receiver and a display screen for communication with the remote server. It is contemplated that the notification that can be selected by the user can include, without limitation, one or more of visual or aural notifications from the signal device, service messages, e-mail, notifications on a user's smartphone, and the like.

In a further aspect, in an embodiment having multiple pets and multiple collars 4, it is contemplated that a passive RFID circuit can be coupled to each collar 4, which can be configured to be selectively activated by the sensing device 20. In this aspect, identification of particular collars and thus individual pets can be determined by interrogation of the otherwise passive RFID circuit by the sensing device 20 and the subsequent comparison of an RFID circuit identification signal received from the RFID circuit to stored RFID identifiers of the respective RFID circuits on the collars 4 in the memory 62 of the signaling device. Thus, the user can be provided notification of the particular pet that is in proximity of the selected door.

It should be emphasized that the above-described embodiments are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual embodiments or combinations of elements or steps are intended to be supported by the present disclosure. Moreover, although specific terms are employed herein, as well as in the claims which follow, they are used only in a generic and descriptive sense, and not for the purposes of limiting the described invention, nor the claims which follow.

What is claimed is:

1. A pet training system for a pet of a user, the pet wearing a collar, the system comprising:
a collar module configured to be fixed to the collar and comprising a permanent magnet;
a sensing device comprising:
a magnetic field sensor configured to sense magnetic flux in a X-axis, a Y-axis, and a Z-axis;
a processor operably coupled to the magnetic field sensor, and
a memory operably coupled to the processor;
a software application resident in the processor and memory of the sensing device that is configured to a) calculate a scaler magnetic state value in proximity to the sensing device based on the sensed magnetic flux on the X, Y and Z axes-axis, and b) compare the determined scaler magnetic state value to a selected scalar threshold value; and
a means for warning the user that the pet is within the sensed proximity of the sensing device if the scaler magnetic state value exceeds the selected scalar threshold value.

2. The pet training system of claim 1, wherein the permanent magnet has a magnetic field strength of between about 0.1 T to about 2.5 T.

3. The pet training system of claim 1, wherein the permanent magnet has a magnetic field strength of between about 0.6 T to about 1.0 T.

4. The pet training system of claim 1, wherein the permanent magnet is integrated within the collar.

5. The pet training system of claim 1, wherein the sensing device further comprises a circuit that can include at least a power source that is operably coupled to the processor and memory.

6. The pet training system of claim 5, wherein the sensing device further comprises:
a LED power indicator configured to indicate that the circuit is in an active state; and
a power button configured to activate the circuit.

7. The pet training system of claim 1, wherein the magnetic field sensor is configured to measure magnetic flux on each of three cardinal axes to determine the value of the environmental magnetic flux on each of the three axes.

8. The pet training system of claim 5, wherein the processor and memory further comprises a software application that is configured to signal the magnetic field sensor to measure magnetic flux on each of three cardinal axes (X-axis, Y-axis, and Z-axis) for determination of the value of the environmental magnetic flux on each of the respective three axes for the area in which the sensing device is mounted for subsequent processing to determine an environmental magnetic vector which is stored in the memory.

9. The pet training system of claim 8, wherein the determined value of the environmental magnetic flux on each of the respective three cardinal axes is used to initialize a plurality of third-ordered bandpass filters, wherein each third-ordered bypass filter of the plurality of third-ordered bypass filters is operably coupled to the magnetic field sensor, wherein a respective third-ordered bypass filter receives the sensed magnetic flux from one respective axis and generates a sensed and filtered magnetic flux for the respective axis.

10. The pet training system of claim 9, wherein each third-ordered bypass filter is configured to only allow passage of a desired spectrum of frequencies between about 0.010 Hz to about 0.030 Hz.

11. The pet training system of claim 9, wherein the magnetic field sensor is configured to continuously measure three orthogonal components (X-axis, Y-axis, and Z-axis) of the magnetic field and input these measurements into the respective third-ordered bandpass filters.

12. The pet training system of claim 11, wherein the software application is further configured to calculate the scaler magnetic state value based on the sensed and filtered values of magnetic flux generated by the plurality of third-ordered bypass filters for each of the orthogonal components.

13. The pet training system of claim 11, wherein the software application is further configured to determine a pet dwell time based on the time that a filtered threshold is exceeded, wherein, if the pet dwell time exceeds a predetermined dwell time, the user is notified.

14. The pet training system of claim 1, further comprising means for warning the user that the pet is within the sensed proximity of the sensing device.

15. The pet training system of claim 14, wherein the means for warning the user comprises:
at least one remote server;
a wireless transmitter that is coupled to the processor;
wherein the software application is configured, upon determination that the scaler magnetic state value exceeds the selected scalar threshold value, to relay, via the transmitter, a warning signal containing a unique identifier of the signal device and/or the collar module to the remote server.

16. The pet training system of claim 1, further comprising a passive RFID circuit coupled to the collar.

17. A pet training system for a pet of a user, the pet wearing a collar, the system comprising:
a collar module configured to be fixed to the collar and comprising a permanent magnet;
a sensing device comprising:
a magnetic field sensor configured to sense magnetic flux in a X-axis, a Y-axis, and a Z-axis;
a plurality of third-ordered bypass filters, wherein each third-ordered bypass filter of the plurality of third-ordered bypass filters is operably coupled to the magnetic field sensor and wherein a respective third-ordered bypass filter receives the sensed magnetic flux from one respective axis;
a processor operably coupled to the plurality of third-ordered bypass filters top received sensed and filtered magnetic flux on the X-axis, the Y-axis, and the Z-axis, and
a memory operably coupled to the processor;
a software application resident in the processor and memory of the sensing device that is configured to a) calculate a scaler magnetic state value in proximity to the sensing device based on the sensed and filtered magnetic flux on the X, Y and Z axes, and b) compare the determined scaler magnetic state value to a selected scalar threshold value; and
a means for warning the user that the pet is within the sensed proximity of the sensing device if the scaler magnetic state value exceeds the selected scalar threshold value.

18. The pet training system of claim 17, wherein the software application is further configured to determine a pet dwell time based on the time that a filtered threshold is exceeded, wherein, if the pet dwell time exceeds a predetermined dwell time, the user is notified.

19. The pet training system of claim 17, further comprising means for warning the user that the pet is within the sensed proximity of the sensing device.

20. The pet training system of claim 19, wherein the means for warning the user comprises;
at least one remote server;
a wireless transmitter that is coupled to the processor;
wherein the software application is configured, upon determination that the scaler magnetic state value exceeds the selected scalar threshold value, to relay, via the transmitter, a warning signal containing a unique identifier of the signal device and/or the collar module to the remote server.

21. The pet training system of claim 17, wherein the permanent magnet has a magnetic field strength of between about 0.1 T to about 2.5 T, and wherein the permanent magnet is integrated within the collar.

22. The pet training system of claim 17, wherein each third-ordered bypass filter is configured to only allow passage of a desired spectrum of frequencies between about 0.010 Hz to about 0.030 Hz.
